(19) United States
(12) Patent Application Publication
(10) Pub. No.: US 2017/0371901 A1
(43) Pub. Date: Dec. 28, 2017

(54) CHIEF DATA OFFICE STRATEGY APPLICATION

(71) Applicants: SHAIK MOHAMMAD ASSAD, WEXFORD, PA (US); SHAHINA SHAIK, WEXFORD, PA (US)

(72) Inventors: SHAIK MOHAMMAD ASSAD, WEXFORD, PA (US); SHAHINA SHAIK, WEXFORD, PA (US)

(21) Appl. No.: 15/162,339

(22) Filed: May 23, 2016

(51) Int. Cl. G06F 17/30; G06Q 10/06

(52) U.S. Cl. CPC G06F 17/30292; G06F 17/3056; G06Q 10/0637

(57) ABSTRACT

A system for Chief Data Office is provided, as well as a defined structure, that has not previously existed, to expedite the process and reduce room for error while saving valuable time and money for those managing Chief Data Office. The predefined templates included in the software greatly reduce the room for error while making data management easier for all of those involved. Now that industries are transforming into more computer centered data storage models, the value of data is quickly becoming recognized, and the need for tools such as this to improve accuracy, value and efficiency are in exceedingly high demand, with no other tool such as this existing today.

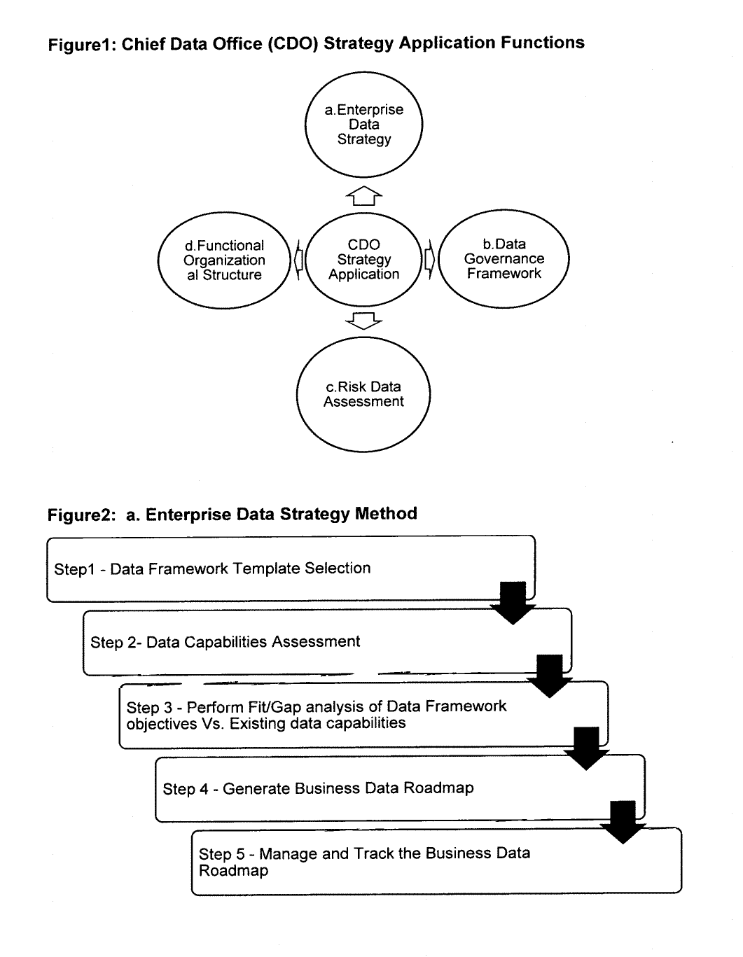

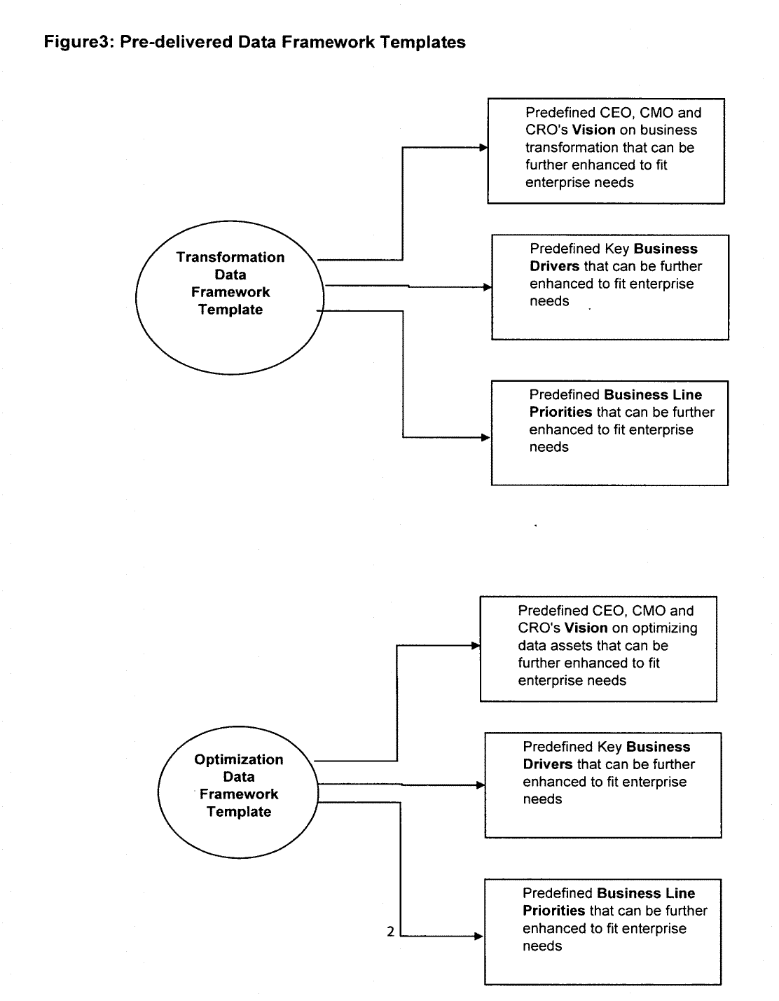

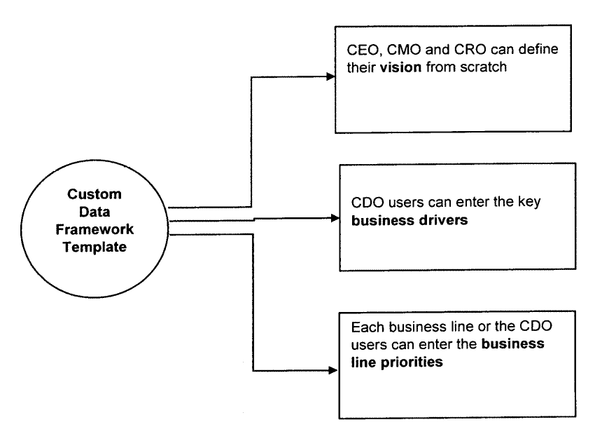

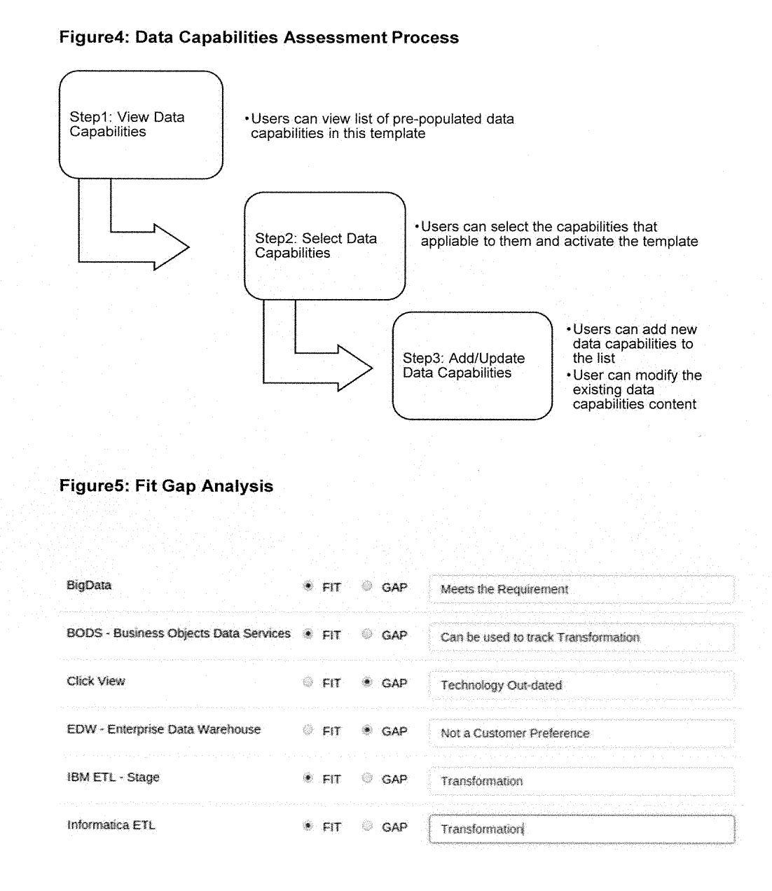

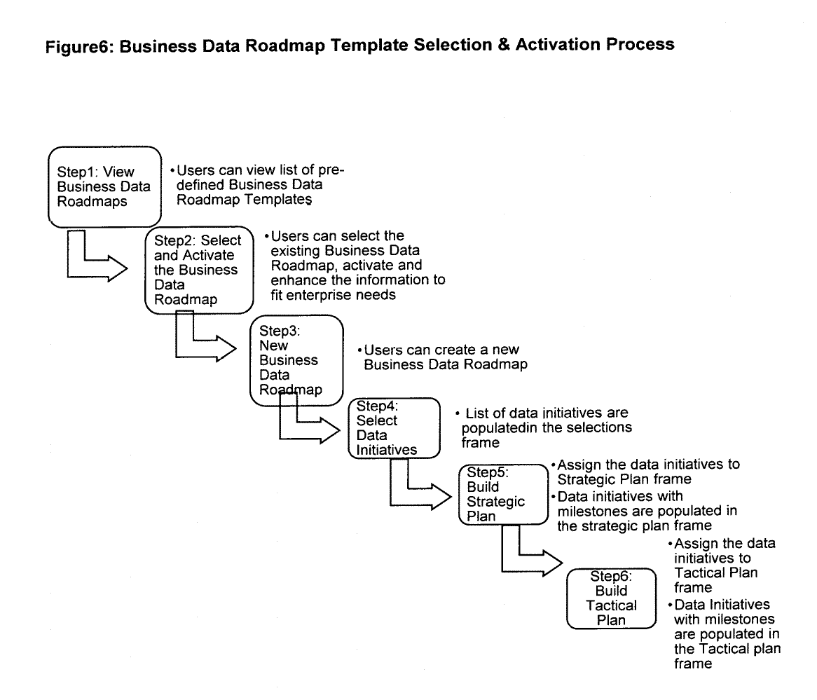

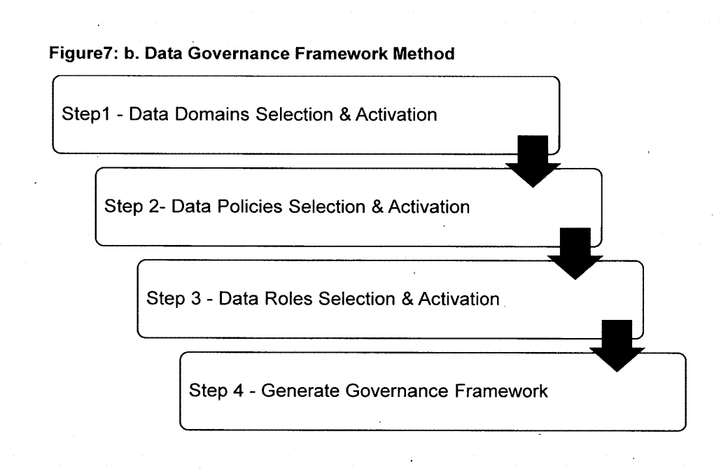

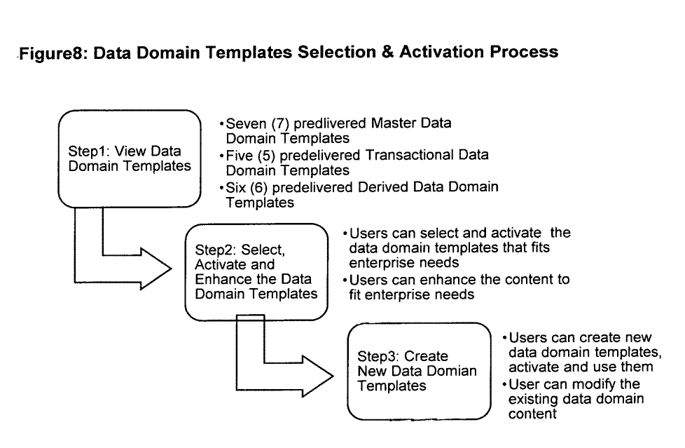

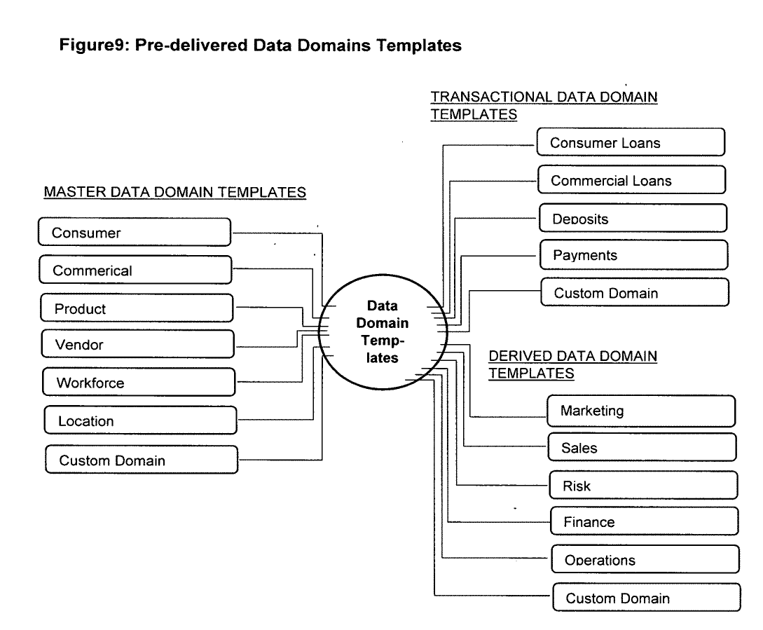

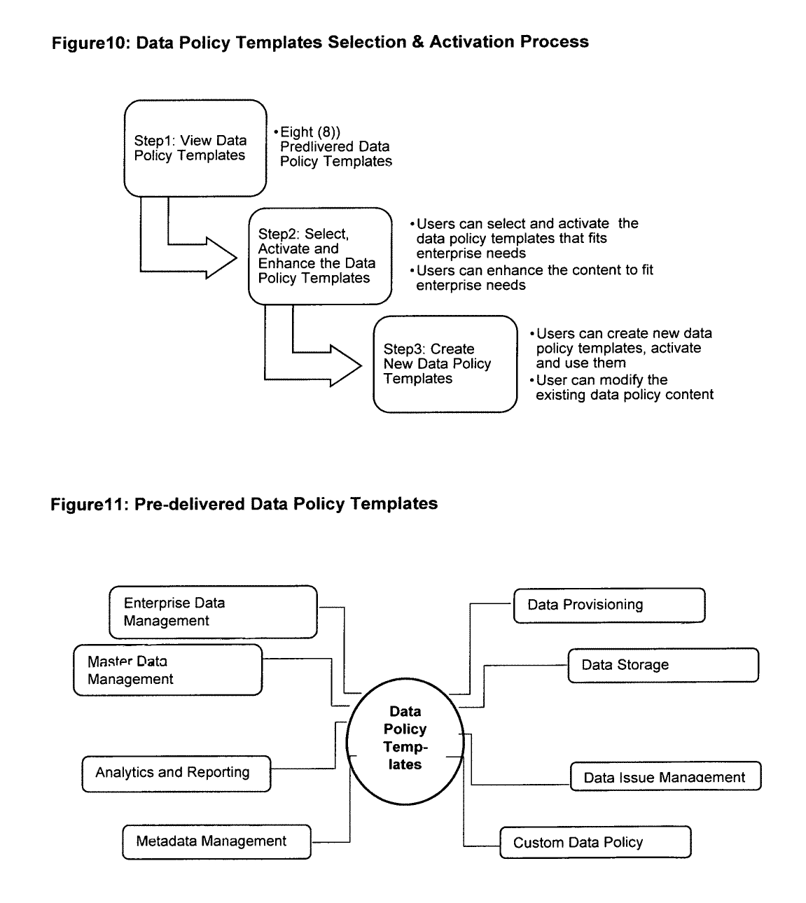

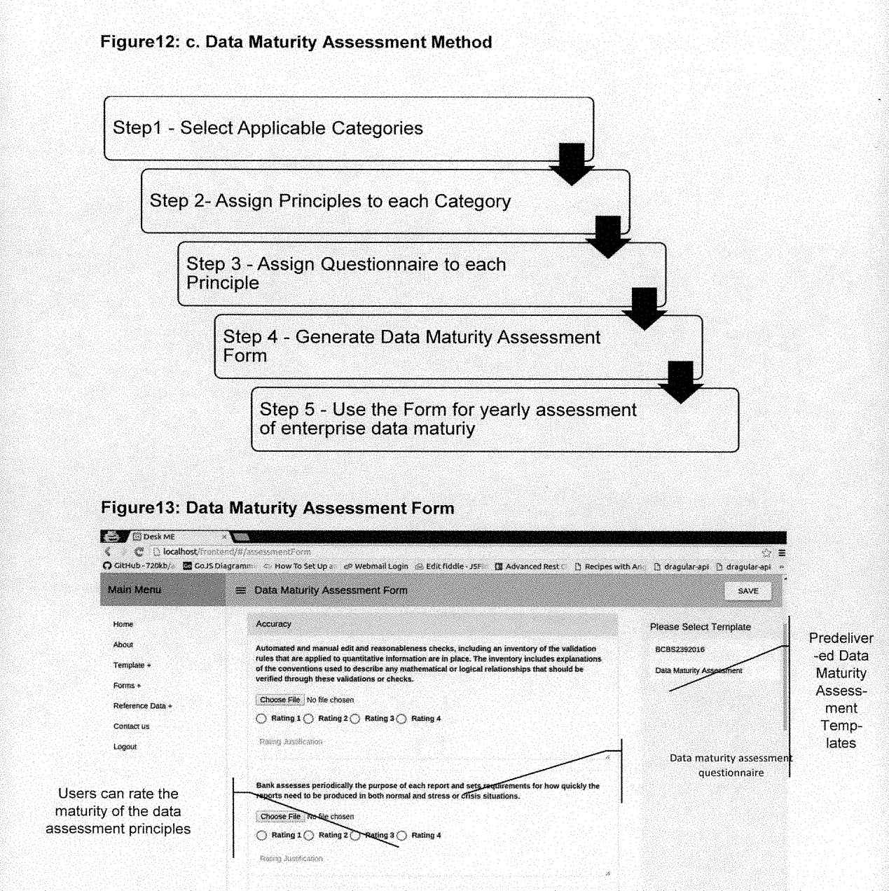

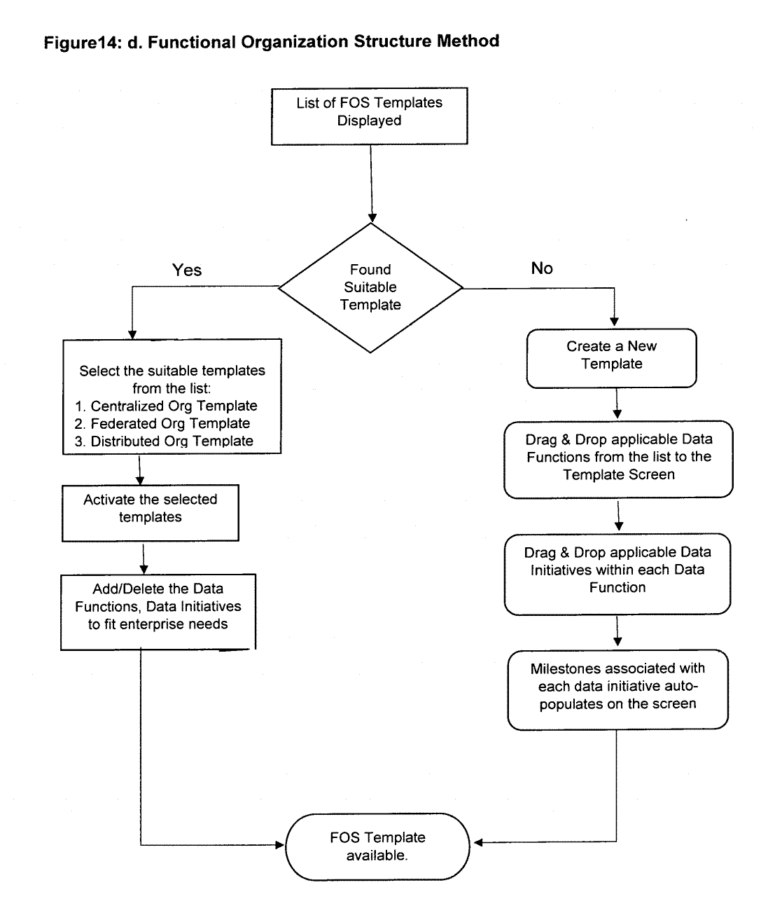

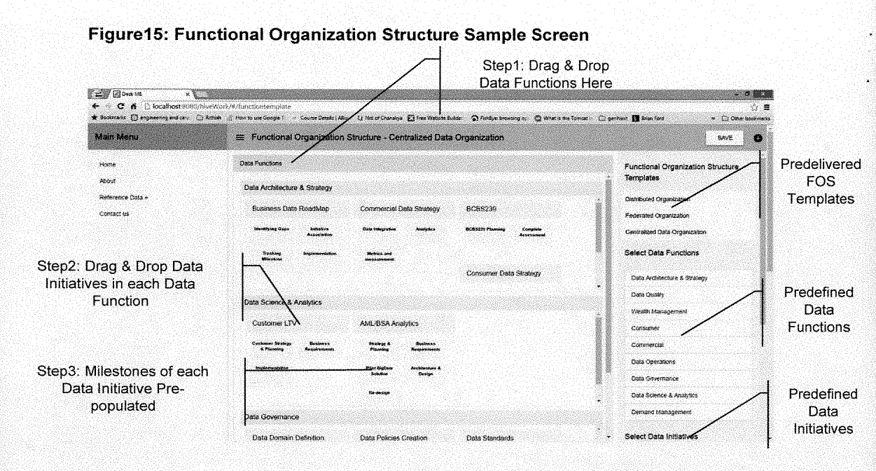

### FIELD OF INVENTION

This system is a handy application designed and developed to support Chief Data Office functions. Chief Data Officers or Head of the Data and Analytics groups can leverage this application to quickly define and manage the enterprise data strategy, and related functions, a task that normally involves spending years of time and tens of millions of dollars, is simplified into a one-month template driven process, with software automating some of the banking industry's most stringent reporting guidelines and assessments. Most importantly, it minimizes the risk of error because of its predefined industry standard templates.

### BACKGROUND/DISCUSSION

In the absence of this tool which does not currently exist today, Chief Data Officers spend their time on efforts resulting in up to several years and tens of millions of dollars of investments. The lack of a standard for enterprise data strategies is clearly causing issues industry wide, as organizations come across various dilemmas. These dilemmas are complex questions such as, “Should they explore and address more revenue generating mechanics, support the regulatory compliances or maintain a pace with evolving business transformation strategies?” “What type of data strategy fits a centralized organization vs. federated or distributed organization?” “How do we address the strategic priorities vs. tactical problems?” These are confusions every Chief Data Officer will experience without this application, and the ability for users to select a template that most closely matches their needs eliminates this, as well as the room for error.

Based on my experience and successes at various companies in a variety of industries, I developed a methodology that addresses this complex problem at its root. Although the science may not seem very complex, it has been shown to help keep data teams more focused, while realizing the business value in regular intervals. Defining an Enterprise Data Strategy is a five step process, and can simplified with this program which contains a number of predefined templates, saving valuable time and money among a wide variety of organizations.

No other application existing today for the Chief Data Officer or the data and analytics team leads to, from a predefined template without working from scratch:
defining and managing enterprise data strategy and business data roadmap.
defining and managing enterprise data management functions like data operations, data science and analytics, data governance, data quality, data administration, data architecture and strategy
capturing, prioritizing and managing the data demand
planning, executing and tracking data initiatives
performing data maturity assessment, comparing and contrasting the data maturity of past 5 years
creating data governance organization setup with data domains, policies and standards.

This application is a handy tool that comes with pre-defined standard templates, custom for a variety of industries. Users can select the suitable template for each function that is closest to their company business, and then further extend it as needed. It can be used in virtually any platform, including Hadoop, RDBMS like Oracle, and SQL Server. Using this application, a CDO will be able to do the above listed activities in less than a month—saving time and millions of dollars. Most importantly, the room for costly errors is greatly reduced due to the predefined industry standard templates.

### SUMMARY OF THE INVENTION

The application is extremely innovative and unique regarding its specific abilities and functions. Its objective is to create a robust and powerful application for the Chief Data Officers that will help them define the Enterprise Data Management Organizations and its related functions quickly, resulting in more reliable data experiences for customers, as well as those working in the industry.

CDO application will present the following features, making it user-friendly, efficient and highly valuable:
This application comes with pre-defined, industry standard templates from which to choose and enhance to fit enterprise needs, eliminating the need to start from scratch and spend years of time and millions of dollars.
It provides pre-defined templates of industry best practice, data strategies from which to choose and enhance based on a company's needs. Several data strategy templates are provided, including the “data transformation strategy,” “data optimization strategy” and “custom data strategy.”
This application addresses four key data management areas, which are:
1) Enterprise Data Strategy,
2) Data Governance Framework,
3) Risk Data Assessment, and
4) Functional Organization Structure
It allows users to standup the data governance framework, to select data domains from the pre-defined templates, as well as select data policies and data standards.
It provides the data maturity assessment templates, allowing the company to assess the maturity of data capabilities and related functions. Users can compare 5 years of data maturity progress. These templates come pre-populated.
This application provides pre-populated reference data screens of Data Objects, Critical Data Elements, Guiding Principles and Standards.
This application provides industry standard pre-defined Domains and Policies templates to select from and manage the data governance tasks.
It provides pre-defined industry standard CDO organization templates for Chief Data Officers to use. These templates may be used as is or enhanced based on need. It can manage a four tier chief data office organizational structure.
   Tier 1 is the CDO “Chief Data Office”
   Tier 2 includes the pre-defined CDO functions like data demand management, data governance, data science, data operations, data quality, data strategy and architecture
   Tier 3 includes the pre-defined data management initiatives under each data function. E.g., MDM, BigData, Metadata, Data Governance, Anti-Money Laundering/Bank Secrecy Act, Fraud Analytics, Customer Lifetime Value, Digital Platform
   Tier 4 includes the pre-defined milestones under each initiative
Defining an Enterprise Data Strategy is a five step process.
This application provides predefined industry standard Data framework templates
Data capability user screen allows users to quickly assess the data capabilities.
Fit/Gap analysis template pre-populates the leadership vision, business drivers and business line priorities. It allows the users to compare with data capability assessment, and the outcome of the comparison is either a Fit or Gap. All Gaps are converted into data initiatives.
Business data roadmap user screen is one of the key features of the enterprise data strategy, providing a plan to address both the strategic goals and tactical problems resolution.
This application provides pre-populated CDO functions, and Data initiatives.
Users can select the suitable initiatives and define the milestones.
Users can drag and drop the data functions and initiatives under each function.
Initiative Milestones will be populated from the initiative reference data tables.
It provides 360 degrees' view of data demands, from capturing the demand, mapping to inflight initiatives and tracking the status of each milestones.

Yet another remarkable objective of the application will to be to define separate sets of milestones for every single capability. The application will also come with the additional ability to assign the various individuals who are supposedly responsible for handling and managing every single capability.

This application is not existing in the current market and is thus, the first of its kind. Therefore, this invention will set the foundation for defining enterprise database management operations easily, without any hassle.

This application has an option to select from predefined templates for almost every concept in the application. Its flexibility to work within almost any database, such as Hadoop, RDBMS like Oracle and SQL servers, is combined with its flexible drag and drop features, which eliminate manual entry into the application, further eliminating the room for error.

### APPLICATION ARCHITECTURE

Presentation Layer

Technologies used:

ANGULAR JS, ANGULAR MATERIAL, HTML 5, JSON.

Brief Summary
User Interface (UI) provides rich user experience and is easy to navigate the pages. Options like Drag and Drop eases the way the user gives input.
It's also possible to create templates and reuse the template with different options. Angular Material provides light-weight UI controls. Hence, accessing UI becomes faster.
CRUD operations for different modules like Enterprise Data Strategy, Data Framework and Risk Data Assessment can be accomplished easily.

Services Layer

Technologies used:

Spring REST, Spring MVC, Hibernate.

Brief Summary:
Spring controller processes the request received from the client, and routes to corresponding REST implementation.
Spring REST uses Service Classes, Entity classes, Hibernate, DAO

Implementation to perform CRUD operations in the Database.
Hibernate provides option to switch the DB without changing much code in the service Layer.

Persistent Layer

This application supports Hadoop's HIVE and relational data bases like Oracle, MySQL and MS SQL Server.

### DETAILED DESCRIPTION OF THE EMBODIMENTS

Drawing 1: Chief Data Office (CDO) Strategy Application Functions

This application is categorized into four modules, each addressing a different data function, these functions are:
a. Enterprise Data Strategy
b. Data Governance Framework
c. Risk Data Assessment
d. Functional Organization Structure, which is also known as Chief Data Office Management Organization

Drawing 2: a. Enterprise Data Strategy Method

Enterprise data strategy is the first and the core module of CDO Strategy Application. EDS is a five step method to help the organizations quickly generate a Business Data Roadmap. A user of CDO Strategy application has to perform all five steps in sequence, leverage pre-defined templates that best fit enterprise needs, and generate the Business Data Roadmap. These steps are:
1. Data Framework Template Selection: This application provides templates with pre-populated enterprise and business unit objectives. Users can select the template that best fits the enterprise needs and enhance it further, or Users can create a custom template from scratch, and populate the enterprise and business unit objectives.
2. Data Capabilities Assessment: This is the second step in the EDS process. This step provides a template with pre-populated required data capabilities to meet the enterprise and business unit objectives. Users can enhance the information to best fit the enterprise business needs, or create a custom template from scratch with information as needed by the enterprise.
3. Perform Fit/Gap analysis of Data Framework Objectives vs. existing data capabilities; this is a two-step process, of assessing the existing data capabilities initially and performing fit/gap by comparing with Step 2 “required data capabilities.”
4. All gaps identified as part of fit/gap analysis are converted into data initiatives, and one or more milestones can be defined to each data initiative and assign the person responsible. The outcome of this process is a Business Data Roadmap, which illustrates both the strategic initiatives and tactical plan in a quarterly schedule with multi-year roadmap.
5. Manage and Track the Business Data Roadmap. This is a final step of allowing the users to constantly update/sync the changes to the initial business roadmap, by leveraging the demand management process of capturing the demand, aligning with existing initiatives/milestones, and revising the business priorities.

Drawing 3: Defining a Data Framework

The first step in an enterprise data strategy is to define a Data framework. This framework template would primarily consist of the following:
An efficient leadership vision
Key business drivers
Individual business line priorities.

User have three options to select the templates, which are:

Template 1—Transformation Framework

This template comes with pre-defined data framework populated with the leadership vision, business drivers and business line priorities that are aligned with the transformational change. Users will be able to select this template, activate and make necessary changes to fit their business needs.

Template 2—Optimization Framework

This template comes with pre-defined data framework populated with the leadership vision, business drivers and business line priorities that are aligned with optimizing data and related assets. Users will be able to select this template, activate and make necessary changes to fit their business needs.

Template 3—Custom Framework

Users can create a customer data framework from scratch and define the Leadership vision, Business drivers and Business Line priorities.

Drawing 4: Assessment of Existing Data Capabilities

This template allows the user to leverage the data capabilities assessment template, capture and assess the organizations data capabilities. This template helps user to select/enter following information:
What are your existing data standards, processes and policies?
Do you have any redundant data stores?
Are there any redundant processes and people who are managing those processes?
Is your organization facing outdated technical capabilities?
Are your processes scalable?

Drawing 5: Fit/Gap Analysis

This template allows the users to compare the required data capabilities captured in the Step 2 of EDS process with the existing data capabilities captured in the Step 3, and identify the fits and gaps. Each comparison of required capabilities vs. existing capabilities is marked as either a fit or gap.

Data Initiatives

This template populates all identified gaps from Fit/Gap analysis, and convert into data initiatives, allowing users to enter one or more milestones for each data initiative.

Drawing 6: Business Data Roadmap

This template comes with initiative lists that have been identified in the Fit/Gap analysis. Users can move the initiatives into strategic Vs tactical plan and define milestones.

Here are some examples of the kind of strategic initiatives and tactical problems your firm can face and the solutions you should use:
Typical strategic initiatives:
   Implementing master data management solution to establish a centralized customer onboarding process, and efficiently manage customer information in a single version of truth, and improve customer experience.
   Implementing Big data solutions to perform largescale, real-time analytics in a distributed computing platform. This will help in carrying out better analytics on customer life time value. Further, you should promote the use of sophisticated machine learning concepts to detect the predicated offenses of money laundering and real-time fraud detection.
   Establishing data governance organization to govern and manage the data.
   Implementing cognitively intelligent mechanics to better understand and serve the customers.
Tactical problems:
   Fix the critical data quality issues to continue supporting key reports and analytics.
   Minor enhancements, fixes or upgrades to the existing data capabilities that support business processes, reports or analytics.

Template 1—Three Year

This template comes with pre-defined data initiatives supporting both strategic and tactical goals of the organization, with strategic goals realizing business value from 1 to 3 years in defined yearly intervals.

Template 2—Five Year

This template comes with pre-defined data initiatives supporting both strategic and tactical goals of the organization, with strategic goals realizing business value from 2 to 5 years in defined yearly intervals.

Template 3—Custom

Users can create a customized business data roadmap from scratch, with strategic and tactical goals.

Drawing 7: Data Governance Framework Method (DGFM)

Enterprise data governance framework is the second module of CDO Strategy Application. DGFM is a four step method to help the organizations quickly define and standup enterprise data governance framework. A user of CDO Strategy application can leverage pre-defined templates, of Data domains and Data Policies, that best fit enterprise needs and generate a DGF. These steps are:
1. Data Domains Selection & Activation: DGF module provides templates with pre-populated data domains and domain related information. Users can select the domain templates that best fits the enterprise needs and enhance it further, or Users can also create a custom template from scratch, and create new data domains.
2. Data Policy Selection & Activation: DGF module provides templates with pre-populated data policies and policy related information. Users can select the policy templates that best fits the enterprise needs and enhance it further, or Users can also create a custom template from scratch, and create new data policies.
3. Data Roles Selection & Activation: DGF module provides templates with pre-populated Data governance roles & and industry standard responsibilities. Users can select the data roles/responsibilities that best fits the enterprise needs and enhance further, or User can also create custom data roles and related responsibilities from scratch.
4. Generate Governance Framework: This is the final step in DGFM that allows the enterprise to start using the selected data domains, data policies, roles and responsibilities.

Drawings 8 and 9: Data Domains

Data domains are an industry-standard approach to logically organize data into categories to enable identification of clear ownership and accountability over data in a way that transcends individual systems or business units.

Domains are categorized into Master, Transactional and Derived data domains.

Master Domain Templates

These templates come with pre-defined financial industry standard master data domain, with pre-populated critical data elements. User can select this template, activate and enhance the critical data elements associated with this domain.

Template 1—Consumer

Template 2—Commercial

Template 3—Product

Template 4—Vendor

Template 5—Workforce

Template 6—Location

Template 7—Custom Domain

Users can create a custom domain from scratch and assign the critical data elements.

Transactional Domain Templates

These templates come with pre-defined financial industry standard Transactional data domain templates with pre-populated critical data elements. User can select this template, activate and enhance the critical data elements associated with this domain.

Template 1 —Consumer Loans

Template 2—Commercial Loans

Template 3—Deposits

Template 4—Payments

Template 5—Custom Domain

Derived Domain Templates

These templates come with pre-defined financial industry standard Derived data domain templates with pre-populated critical data elements. User can select this template, activate and enhance the critical data elements associated with this domain.

Template 1—Marketing

Template 2—Sales

Template 3—Risk

Template 4—Finance

Template 5—Operations

Template 6—Custom Domain

Drawings 10 and 11: Data Policy

Policy establishes responsibility and accountability to ensure that a comprehensive, rigorous and transparent data management framework is utilized to enforce the identification, escalation and remediation of issues within the Chief Data Office organization, a control unit led by the Chief Data Officer.

These templates are pre-populated with the Policy statement, Overview, Guiding Principles, Policy Standards and references. Users can activate and extend the policy information to fit their business needs. User also has the option to create one or more policies from scratch with their organization specific requirements.

Template 1—Enterprise Data Management Policy

Template 2—Master Data Management Policy

Template 3—Analytics & Reporting Policy

Template 4—Metadata Management Policy

Template 5—Data Provisioning Policy

Template 6—Data Storage Policy

Template 7—Data Issue Management Policy

Template 8—Custom Data Policy

Drawings 12 and 13Data Maturity Assessment (DMA)

DMA is the third module of CDO Strategy Application. The application process selects the most suitable data maturity assessment template, activating and enhancing to fit the enterprise needs. The users can view the list of data maturity assessment templates, select the templates that best fit their business needs, and activate them. After activation, users will have the option to make any changes to the pre-delivered content. Using this template, the user will be able to provide the ratings of data maturity principles questionnaire on a scale of 4, provide rating justification and attach artifacts to support the ratings.

Drawings 14 and 15: Functional Organizational Structure

It provides pre-defined industry standard CDO functional organization templates for Chief Data Officers to use. These templates may be used as is or enhanced based on need. It can manage a four tier chief data office organizational structure.
Tier 1 is the CDO “Chief Data Office.”
Tier 2 includes the pre-defined CDO functions like data demand management, data governance, data science, data operations, data quality, data strategy and architecture.
Tier 3 includes the pre-defined data management initiatives under each data function. E.g., MDM, BigData, Metadata, Data Governance, Anti-Money Laundering/Bank Secrecy Act, Fraud Analytics, Customer Lifetime Value, Digital Platform.
Tier 4 includes the pre-defined milestones under each initiative.

### SYSTEM AND METHOD OF CHIEF DATA OFFICE MANAGEMENT APPLICATION

This application comes with pre-populated reference data, and pre-defined templates. Users can select the closest match and further enhance the information to fit the organization's needs.

Pre-Defined Templates:

1. CDO Functional Organization Structure

2. Data Frameworks

3. Data Capabilities

4. Business Data Roadmap

5. Data Domains

5. Data Policies

7. Data Initiatives

Pre-Populated Reference Data Screens:

8. Principal Category

9. Principals

10. Questionnaire

11. Team

12. Team Members

13. Domain Category

14. Domain Owner

15. DataObject Category

16. Data Object

17. Ownership

18. Status

19. Guiding Principal

20. Standard Overview

21. Milestone

What is claimed:

1- CDO application process This application provides a process, methodology and templates, to quickly setup the chief data office by defining and managing the enterprise data strategy, data governance framework, risk data assessment and CDO functional organization.

2- Enterprise Data Strategy Application Process This application module provides a process, methodology and templates, to quickly setup the enterprise data strategy; Enterprise data strategy is a 5 step process of:
Step 1: Defining Corporate and Business unit objectives;
Step 2: Identification of required data capabilities to support the Corporate and Business Unit objectives;
Step 3: Identification of existing data capabilities to support the corporate and Business unit objectives;
Step 4: Identification and definition of data initiatives, by performing Fit/Gap between step 2 and step 3 and
Step 5: Generating Business Data Roadmap, with both strategic and tactical initiatives with detailed plan.

3- Data Framework Templates; claim 3 is dependent on claim 2, where defining the corporate and business unit objectives are necessary; Pre-delivered industry best practice data framework templates from which to choose and enhance to fit enterprise needs, eliminating the need to start from scratch with the following options:
Template 1—Data Transformation Framework that is pre-populated with the leadership vision, business drivers and business line priorities that are aligned with the transformational change; users will be able to select this template, activate and make necessary changes to fit their business needs; Template 2—Data Optimization Framework that is pre-populated with the leadership vision, business drivers and business line priorities that are aligned with optimizing data and related assets; users will be able to select this template, activate and make necessary changes to fit their business needs; Template 3—Custom Framework where users can create a customer data framework from scratch and define the Leadership vision, Business drivers and Business Line priorities.

4- Data Capabilities Template; claim 4 is dependent on claim 2, where the Identification of required data capabilities support the Corporate and Business Unit objectives, and this template comes with pre-defined common data capabilities that might be required to support the generic corporate and business unit objectives from which to choose and enhance to fit enterprise needs, eliminating the need to start from scratch; using this template, user can quickly check the capabilities that are existing within the enterprise, highlight the issues or opportunities associated with these capabilities.

5- Fit/Gap Analysis Application Screen; claim 5 is dependent on claim 2 to help Identification of existing data capabilities to support the corporate and Business unit objectives and Identification and definition of data initiatives, by performing Fit/Gap between step 2 and step 3: the application process of displaying the required capabilities from the “Data Capabilities” tables and allowing user to select the existing data capabilities from the list and comparing with required capabilities to perform the fit/gap analysis; using this application screen, users will be able to populate the required capabilities from data capabilities tables and select existing data capabilities; if the capability is existing and complete, it can be marked as Fit, any capabilities that are not complete or not existing are marked as Gaps; all identified gaps are converted into data initiatives, assigning one or more milestones for each data initiative.

6- Business Data Roadmap; claim 6 is dependent on claim 2, to help generate Business Data Roadmap, with both strategic and tactical initiatives with detailed plan; the application process displays a list of data initiatives on the Business Data Roadmap Application Screen, and allows users to enhance further by drag and drop of the data initiatives on the Business Data Roadmap screen in both the Strategic goals and Tactical problems container/boxes, the outcome of these activities will provide a quarterly view of data initiatives execution plan, with one or more milestones.

7- Data Governance Framework This application module provides a process, methodology and templates, to quickly setup the data domains and data policies; Enterprise data strategy is a 2 step process of:
Step 1: Defining Data Domains and
Step 2: Defining Data Policies.

8- Data Domain Templates; claim 8 is dependent on claim 7 to setup Data Domains, with pre-delivered industry best practice data domain templates from which to choose and enhance to fit enterprise needs, eliminating the need to start from scratch with a list of Pre-Delivered Master Data Domain Templates:
Template 1—Consumer;
Template 2—Commercial;
Template 3—Product;
Template 4—Vendor;
Template 5—Workforce;
Template 6—Location and
Template 7—Custom Domain;
List of Pre-Delivered Transactional Data Domain Templates:
Template 1—Consumer Loans;
Template 2—Commercial Loans;
Template 3—Deposits;
Template 4—Payments and
Template 5—Custom Domain;
List of Pre-Delivered Derived Data Domain Templates:
Template 1—Marketing;
Template 2—Sales;
Template 3—Risk;
Template 4—Finance;
Template 5—Operations and
Template 6—Custom Domain.

9- Activating Existing Domain Templates; claim 9 is dependent on claim 7 to define the Data Domains, where the application process selects the most suitable data domain templates, activating them and enhancing to fit the enterprise needs; the users can view the list of domain templates, select the domain templates that best fit their business needs, and activate them; after activation, users will have the option to make any changes to the pre-delivered content.

19- Creating a Custom Domain Template; claim 10 is dependent on claim 7 defining Data Domains, with the application process creating a custom domain template; If none of the pre-delivered domain templates fits enterprise needs, users can create a new/custom template with enterprise specific information, save the template and use it in the data governance process.

11- Data Policy Templates; claim 11 is dependent on claim 7, defining data domains to setup Data Policies, using Pre-delivered industry best practice data policy templates from which to choose and enhance to fit enterprise needs, eliminating the need to start from scratch; these policies have pre-defined guiding principles and data standards that can be further modified to fit the enterprise needs using a list of Pre-delivered data policy templates:
Template 1—Enterprise Data Management Policy;
Template 2—Master Data Management Policy;
Template 3—Big Data Management Policy;
Template 4—Metadata Management Policy;
Template 5—Data Provisioning Policy;
Template 6—Data Storage Policy and
Template 7—Data Issue Management.

12- Creating a Custom Data Policy Template; claim 11 is dependent on claim 7 defining data domains to create Custom Data Policies, where the application process creates a custom data policy template; if none of the pre-delivered data policy templates fits enterprise needs, users can create a new/custom template with enterprise specific information, save the template and use it in the data governance process.

13- Data Maturity Assessment Templates The application process selects the most suitable data maturity assessment template, activating and enhancing to fit the enterprise needs; the users can view the list of data maturity assessment templates, select the templates that best fit their business needs, and activate them; after activation, users will have the option to make any changes to the pre-delivered content; using this template, the user will be able to provide the ratings of data maturity principles questionnaire on a scale of 4, provide rating justification and attach artifacts to support the ratings; users can also view the comparative analysis of several previous year(s) rating and the data maturity growth graph.

14- Creating a Custom Data Maturity Assessment (DMA) Template; claim 14 is dependent on claim 13, providing an option of creating a custom Data Maturity Assessment Template where the application process creates a custom DMA template; if none of the pre-delivered DMA templates fits enterprise needs, users can create a new/custom template with enterprise specific information, save the template and use it for yearly assessment of data capabilities maturity; users can select the pre-delivered data maturity categories, principles within each category and questionnaire to provide ratings; users will be able to provide the ratings of data maturity principles questionnaire on a scale of 4, provide rating justification and attach artifacts to support the ratings; users can also view the comparative analysis of several previous year(s) rating and the data maturity growth graph.

15- Data Demand Management Application User Screen; claim 15 is dependent on claim 2, generating Business Data Roadmap, with both strategic and tactical initiatives with detailed plan; all the data problems of the Chief Data Office organizations are logged as opportunities in the Demand management function; these opportunities will be prioritized and eventually addressed based on the business criticality; the application process captures the data demand across all business lines, setting-up priorities to each demand, converting the demand into the data initiatives or milestones within each data initiative.

16- Data Demand linking to Business Data Roadmap; claim 16 is dependent on claim 2, generating Business Data Roadmap, with both strategic and tactical initiatives with detailed plan; the application process links the approved data demand to the business data roadmap, under the strategic goals or tactical problems container/box.

17- Functional Organization Structure Template It provides pre-defined industry standard CDO functional organization templates for Chief Data Officers to use; these templates may be used as is or enhanced based on need; it can manage a four tier chief data office organizational structure as described below:
Tier 1 is the CDO “Chief Data Office”;
Tier 2 includes the pre-defined CDO functions like data demand management, data governance, data science, data operations, data quality, data strategy and architecture;
Tier 3 includes the pre-defined data management initiatives under each data function (E.g., MDM, BigData, Metadata, Data Governance, Anti-Money Laundering/Bank Secrecy Act, Fraud Analytics, Customer Lifetime Value, Digital Platform) and
Tier 4 includes the pre-defined milestones under each initiative and resources assigned to each milestone.

18- Creating a Custom Functional Organization Structure (FOS) Template; claim 18 is dependent on claim 17; the application process creates a custom FOS template; if none of the pre-delivered FOS templates fits enterprise needs, users can create a new/custom template with enterprise specific information, save the template and use it in the Chief Data Office management process; user can drag and drop the pre-defined data functions, and place the data initiatives within respective function (initiatives that were captured in Fit/Gap process, and each data initiative have one or more defined milestones).

19- Associating the Teams and Team Members to Functional Organization Structure (FOS) Template; claim 19 is dependent on claim 17; the application process creates a custom FOS template; if none of the pre-delivered FOS templates fits enterprise needs, users can create a new/custom template with enterprise specific information, save the template and use it in the Chief Data Office management process; User can drag and drop the pre-defined data functions, and place the data initiatives within respective function (initiatives that were captured in Fit/Gap process, and each data initiative have one or more defined milestones).

20- CDO Application works on Hadoop, Oracle, Sql Server, Mysql This application has been designed and developed to work of many other types of databases; it can work on Hadoop (HIVE), mysql, Sql Server, Oracle and several other databases; this application uses the Hibernate capability of Java that helps to switch databases without change in code or sql statements.
